(19) United States
(12) Patent Application Publication
(10) Pub. No.: US 2026/0080775 A1
(43) Pub. Date: Mar. 19, 2026

(54) Applications, Systems, and Methods for Geolocating Disparate Mobile Devices and Selectively Associating and Alerting Users Based on Telemetry Data

(71) Applicant: Digital Marketplace Solutions, LLC, Ft. Lauderdale, FL (US)

(72) Inventors: Anthony Huy, Fullerton, CA (US); Zachary Robbins, Peachtree Corners, GA (US); Elizabeth Cale, Long Beach, CA (US); Austin Christensen, Scottsdale, AZ (US); Parker Stromberg, Clearfield, UT (US); Patrick Wulfe, Portland, OR (US)

(21) Appl. No.: 19/325,723

(22) Filed: Sep. 11, 2025

Related U.S. Application Data
(60) Provisional application No. 63/695,158, filed on Sep. 16, 2024.

(51) Int. Cl. G08G 1/01; B60R 25/20; G06F 16/28; G06F 16/29

(52) U.S. Cl. CPC G08G 1/0145; B60R 25/20; G06F 16/287; G06F 16/29; G08G 1/012

(57) ABSTRACT

Systems and methods are provided for a clumping system comprising a telemetry server accessibly by a first device of a first user that receives GPS data from the first device and determines a location and an area classification of the first user based on the GPS data. A clumping application is stored on a non-transitory computer-readable medium and is executed by processors. A community of the first user and identities of entities within the community are received from a telemetry database. Locations of the entities are determined based on GPS data from devices associated with the entities. Distances between the first user and the entities are compared to a predetermined threshold that is based on the area classification. Based on the comparison, the community is designated an active community. The first user is alerted of the active community and the active community is graphically rendered on the first device.

### CROSS-REFERENCE TO RELATED APPLICATIONS

The present application claims priority to U.S. Provisional Application No. 63/695,158, filed Sep. 16, 2024.

### FIELD

The present disclosure relates to applications, systems, and methods for geolocating a plurality of disparate mobile devices and selectively associating and alerting users based on telemetry data.

### BACKGROUND

People may be associated with (e.g., members of) various communities. For example, a plurality of people may belong to a common family or a common sporting group or team, or may be members of an organization. It can be time-consuming and burdensome for users of some systems to determine locations of various members and entities of communities to which they belong. Furthermore, it can be difficult to determine which communities include members in close proximity to one another. For example, location data may be shared upon request or may be shared with each other in different media (e.g., social media, SMS message). It may be advantageous to provide systems and methods of associating entities within a community in a consolidated and navigable way and alerting users when they are within sufficient proximity to associated entities.

### SUMMARY

Systems and methods are provided for a clumping system comprising a telemetry server accessibly by a first device of a first user that receives GPS data from the first device and determines a location and an area classification of the first user based on the GPS data. A clumping application is stored on a non-transitory computer-readable medium and is executed by one or more processors. A community of the first user and identities of entities within the community are received from a telemetry database. Locations of the entities are determined based on GPS data from devices associated with the entities. Distances between the first user and the entities are compared to a predetermined threshold that is based on the area classification. Based on the comparison, the community is designated an active community. The first user is alerted of the active community and the active community is graphically rendered on the first device.

In another example, a method includes detecting that a first user is moving based on Global Positioning System (GPS) data from a first device at a first time and generating a first vector based on the GPS data. A plurality of entities within a common predetermined community as the first user are determined from a data store. For one or more of the entities, a plurality of bounding telemetry points for the entity is determined based on GPS data obtained for the entity. The GPS data for the entity is interpolated to the first time and an entity predicted position is generated based on the interpolation. An entity vector is generated based on the bounding telemetry points. Based on a determination that the entity predicted position is within a predetermined distance of the first device and that characteristics of the first vector and the entity vector are within predetermined thresholds, a determination is made that the first user and the entity are on a common trip. An alert is graphically rendered on the first device based on the common trip.

In another example, a method of using mobile device data as a proxy for vehicle data includes receiving, from a cellular network, mobile device telemetry data specifying a location of the mobile device. A mobile device vector is generated based on the mobile device telemetry data. Vehicle telemetry data is received from a telemetry control unit (TCU) in a vehicle. A vehicle vector is generated based on the vehicle telemetry data. A determination is made that a characteristic of the vehicle vector is within a predetermined threshold of a characteristic of the mobile device vector. While the characteristic of the vehicle vector is within the predetermined threshold of the characteristic of the mobile device vector, the mobile device telemetry data is attributed to the vehicle telemetry data. The attribution of the mobile device telemetry data to the vehicle telemetry data is cleared based on detecting that the characteristic of the vehicle vector is not within the predetermined threshold of the characteristic of the mobile device vector.

In another example, a method comprises receiving, over a telemetry network, a delegation request from a first device associated with a first user. The delegation request specifies a second user and a vehicle. A telemetry database is accessed and a determination is made that the first and second users are members of a common predetermined community based on community data within the telemetry database. Based on the delegation request and the determination that the first and second users are members of the common predetermined community, a plurality of administrative control privileges are distributed to a second device associated with the second user via the telemetry network. The plurality of administrative control privileges allow the second mobile device access privileges to the vehicle.

### BRIEF DESCRIPTION OF THE DRAWINGS

The following detailed description will be better understood when read in conjunction with the appended drawings. For the purpose of illustration, there is shown in the drawings certain embodiments of the present disclosure. It should be understood, however, that the invention is not limited to the precise arrangements and instrumentalities shown. The accompanying drawings, which are incorporated in and constitute a part of this specification, illustrate an implementation of systems and apparatuses consistent with the present invention and, together with the description, serve to explain advantages and principles consistent with the invention.

FIG. 1A depicts an example system for geolocating a plurality of disparate mobile devices and selectively associating and alerting users based on telemetry data, in accordance with some embodiments.

FIG. 1B shows a telemetry network, in accordance with some embodiments.

FIG. 2A depicts an example method for clumping users in a community based on location data, in accordance with some embodiments.

FIG. 2B depicts an example clumping algorithm, in accordance with some embodiments.

FIG. 2C depicts an example clumping algorithm, in accordance with some embodiments.

FIG. 3 depicts examples of a user interface of the clumping application for three example community members before the community members have been clumped, in accordance with some embodiments.

FIG. 4 depicts an example of the user interface once certain community members have been clumped, in accordance with some embodiments.

FIG. 5 depicts additional examples of icons that may be used to display clumped users and vehicles on the clumping application map display, in accordance with some embodiments.

FIG. 6 depicts examples of clumping application user interfaces for clumped community members and a vehicle that are travelling together, in accordance with some embodiments.

FIG. 7 depicts examples of a community list screen for the clumping application, in accordance with some embodiments.

FIG. 8 depicts an example in which the clumping application detects that a plurality of community members are driving together, in accordance with some embodiments.

FIG. 9 depicts an example of interpolating locations of users and vehicles, in accordance with some embodiments.

FIG. 10A depicts an example method of an application for managing data and clumping community members and vehicles in motion, in accordance with some embodiments.

FIG. 10B depicts an example algorithm of clumping trips of users and vehicles, in accordance with some embodiments.

FIG. 11 depicts an example of using mobile device data to supplement vehicle data, in accordance with some embodiments.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

It is to be understood that the phraseology and terminology employed herein are for the purpose of description and should not be regarded as limiting. For example, the use of a singular term, such as, “a” is not intended as limiting of the number of items. Also the use of relational terms, such as but not limited to, “top,” “bottom,” “left,” “right,” “upper,” “lower,” “down,” “up,” “side,” are used in the description for clarity and are not intended to limit the scope of the invention or the appended claims. Further, it should be understood that any one of the features can be used separately or in combination with other features. Other systems, methods, features, and advantages of the invention will be or become apparent to one with skill in the art upon examination of the detailed description. It is intended that all such additional systems, methods, features, and advantages be included within this description, be within the scope of the present invention.

As described above, in some systems and methods it is difficult or burdensome for users to determine parameters (e.g., locations) of other users that are associated with a common community. Moreover, it may be difficult or impossible in some systems to determine entities (e.g., users, physical locations, vehicles) of a community that are sufficiently close to be associated (i.e., “clumped”) with each other. Systems and methods are provided herein for utilizing user, physical location, and vehicle data in conjunction with each other to selectively clump entities of communities, supplement data from one or more entities with data from other entities, and selectively delegate authority to other users within a community. Systems and methods provided herein may thus help facilitate interactions between users associated with common communities and provide visibility and safety advantages for users.

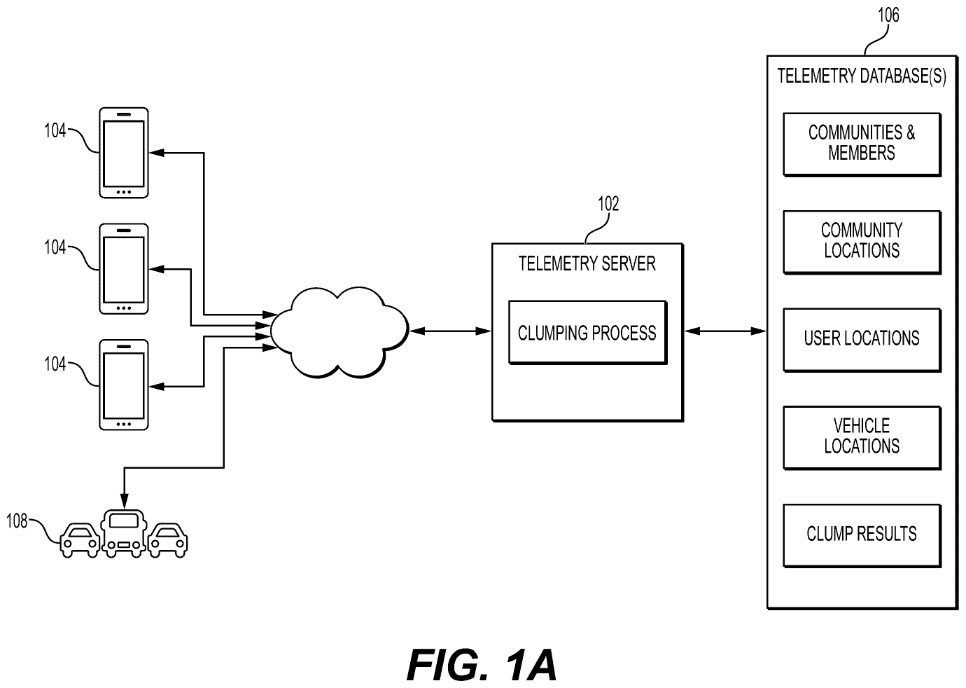

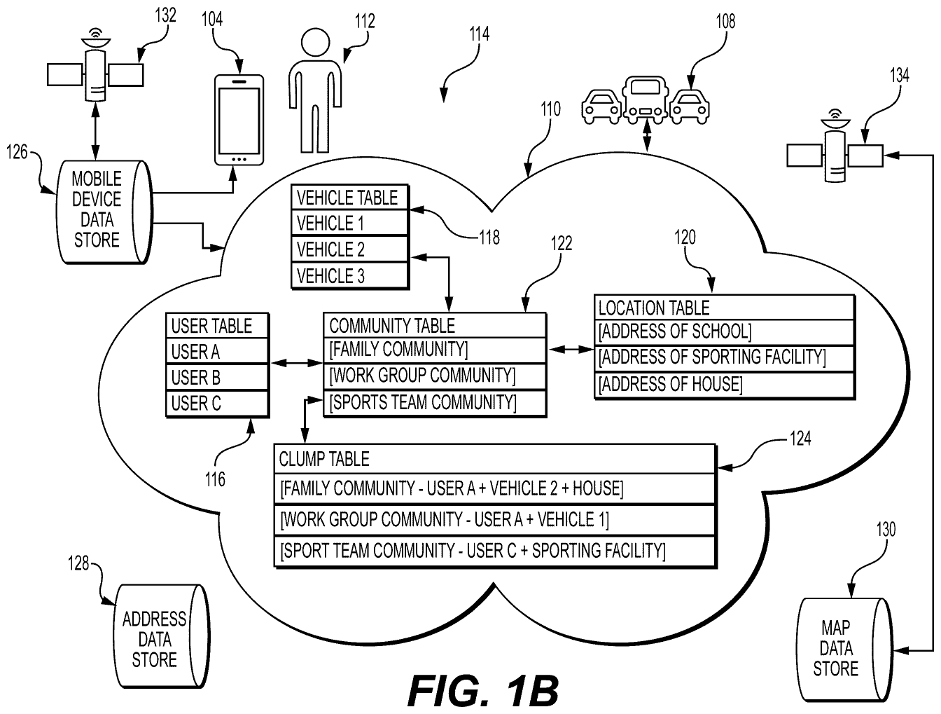

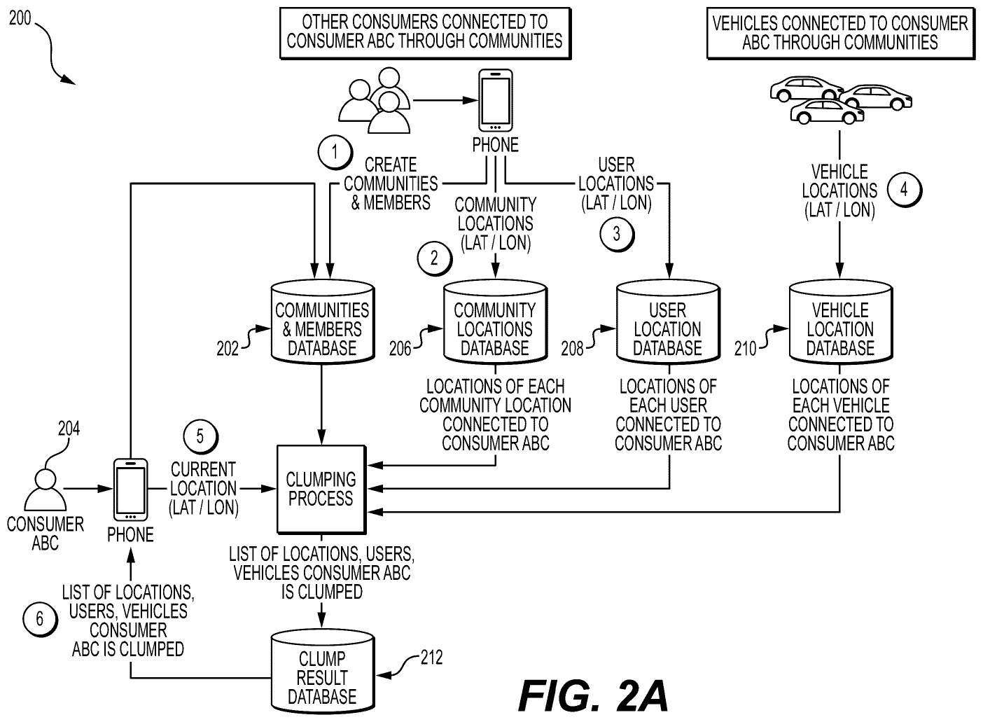

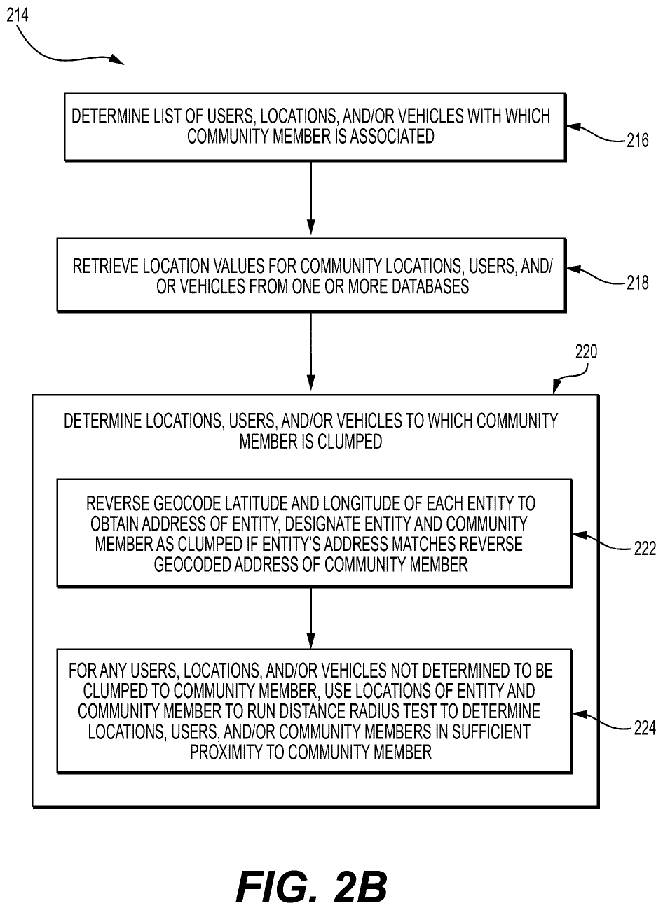

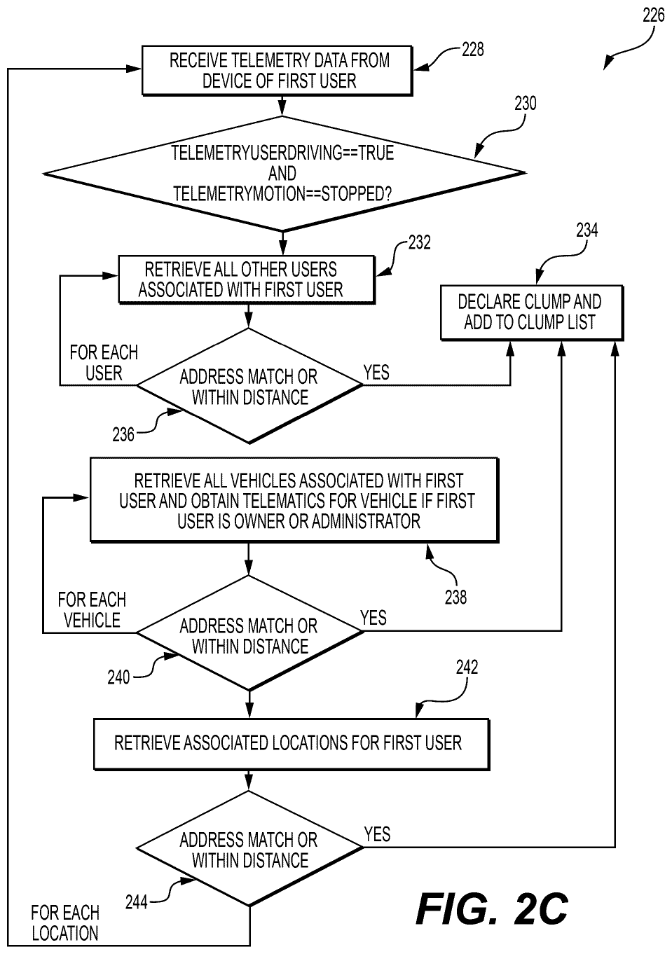

FIG. 1A illustrates an example system for geolocating a plurality of disparate mobile devices and selectively associating and alerting users based on telemetry data, in accordance with some embodiments. The example system 100 includes one or more telemetry servers 102 that execute software instructions stored on one or more computer-readable medium to perform operations described herein, such as the clumping processes described below with reference to FIG. 2. The example system 100 further includes one or more software applications that are stored on and executed by cellular phones 104 or other portable computing devices (generally referred to herein as user devices or cell phones) associated with the community of users, and one or more telemetry databases 106 for storing data generated and/or used by the telemetry server 102 and user devices 104. As illustrated, the telemetry server 102 may also communicate with and/or receive data associated with one or more vehicles 108 that are associated with the community of users. The telemetry server 102 may, for example, communicate with one or more applications on the user devices 104, connected vehicles 108, and/or other sources to generate and/or store information in the telemetry database 106 relating to user communities and their members, community locations, user locations, vehicle locations, and results of a clumping process (as described in more detail below with reference to FIG. 2A). The software application(s) executing on the telemetry server 102 and associated user devices 104 is collectively referred to herein as “the clumping application.”

FIG. 1B depicts a telemetry network, in accordance with some embodiments. As shown in FIG. 1B, the telemetry network 114 includes a database schema structure 110. The database schema structure 110 includes a plurality of tables stored on non-transitory computer-readable mediums. For example, the database schema structure 110 includes a community table 122 specifying a plurality of predefined communities. The predefined communities may be, for example, defined based on user interactions with the clumping application that is installed on devices of the respective users. As shown in FIG. 1B, example predefined communities may be a family community, a work group community, and a sport team community.

The database schema structure 110 further includes a user table 116 specifying a plurality of users within the network 114. The users may be, for example, users having devices with the clumping application installed. The users specified in the user table 116 may be associated with (e.g., members of) one or more of the communities specified in the community table 122. The database schema structure 110 further includes a vehicle table 118 specifying a plurality of vehicles associated with (e.g., owned by) one or more of the users specified in the user table 116. For example, the vehicles listed in the vehicle table 118 may be owned by one or more of the users, or one or more of the users may be an administrator of the vehicle, as described further below.

The database schema structure 110 further includes a location table specifying one or more locations (e.g., addresses) associated with one or more of the communities specified in the community table 122. As shown in FIG. 1B, the one or more locations may include an address of a school, an address of a sporting facility, and an address of a house. For example, the address of the sporting facility may be associated with the sport team community listed in the community table 122.

In addition to specifying the predetermined communities, the community table may identify each of the one or more users, vehicles, and locations that are associated with (i.e., members of) the predetermined communities. For example, one or more entries in the community table 122 may specify that the User A, Vehicle 2, and a specified house is associated with the family community.

The database schema structure 110 further includes a clump table 124. The clump table 124 may be configured to define one or more entities (e.g., users, vehicles, or locations) of a community that are clumped at a predetermined time (e.g., a present time). For example, the clumping table 124 may map particular users from the user table 116, particular vehicles from the vehicle table 118, and particular locations from the location table 120 to entries in the clump table 124 for corresponding communities based on the users, vehicles, and locations that are clumped at the specified time. The determination of the users, vehicles, and locations that are clumped at a given time may be made according to systems and methods described herein.

The telemetry network 114 further includes a map data store 130. The map data store is coupled to the database schema structure 110 and is configured to receive data associated with positions of the users, vehicles, and locations specified in the user table 116, vehicle table 118, and location table 120 from one or more location determining devices 134. The location determining device 134 may be, for example, a Global Positioning System (GPS) satellite, or may be a cellular tower or a localized Wi-Fi network. Furthermore, the map data store 130 may store data that includes terrains (e.g., physical geographic features) associated with the positions of the users, vehicles, and locations. The map data store 130 may be further configured to store area classifications (e.g., urban, rural, suburban, metropolis) associated with the positions of the users, vehicles, and locations. The positions stored in the map data store 130 may be stored, for example, as longitude and latitude coordinates.

The telemetry network 114 may further include a mobile device data store 126. The mobile device data store 126 may be coupled to a device 104 (e.g., phone) of a user 112. The clumping application described herein may be installed on the device 104. The mobile device data store 126 may be configured to receive location data (e.g., GPS data) of the device 104 from a location determining device 132 (e.g., GPS satellite, cellular tower, localized Wi-Fi network). Based on the location data of the device 104, the location of the user 112 may be inferred (e.g., because the user 112 is operating the device 104 and therefore in substantially the same location). The location data may be stored in the mobile device data store, for example, as longitude and latitude coordinates.

The telemetry network 114 may further include an address data store 128. The address data store 128 may be configured to access location data from the map data store 130 and the address data store 128. The address data store 128 may be configured to reverse geocode location data in the map data store 130 and the mobile device data store 126 to determine addresses of the locations. For example, the address data store 128 may retrieve latitude and longitude coordinates associated with the device 104 from the mobile device data store 126 and reverse geocode the coordinates to obtain an address of the device 104 (and thus the user 112).

Furthermore, the telemetry network 114 may be accessible by one or more vehicles 108. One or more identities (e.g., Vehicle Identification Number (VIN) numbers) of the vehicles 108 may be included within the vehicle table 118. Furthermore, location data from the vehicles 108 may be retrieved by the telemetry network 114. For example, GPS coordinates may be obtained from the vehicles 108 via a telemetry control unit (TCU) with the vehicles 108. The location data associated with the vehicles may be stored in the map data store 130. Furthermore, reverse geocoded addresses at which each vehicle 108 is located (e.g., addresses the vehicles 108 are closest to) may be stored in the address data store 128.

The clumping application may utilize data from the map data store 130, the address data store 128, the mobile device data store, and the database schema structure to determine the users, vehicles, and/or locations that are clumped at a given time (e.g., present time). For example, the clumping application may determine, from the community table 122, one or more communities with which the user 112 is associated, as well as other users, vehicles, and locations associated with the one or more communities. The clumping application may then determine, from the map data store 130, locations of the plurality of entities (e.g., users, vehicles, and locations within the one or more communities of the user 112) at the given time. As described above, the locations of the entities stored in the map data store 130 may be latitude and longitude coordinates obtained form the one or more location determining devices 134.

The clumping application may determine distances between the device 104 and each of the entities based on the location data within the map data store 130 and the location data within the mobile device data store 126. The distances between the device 104 and the entities may be compared to a predetermined threshold distance. The predetermined threshold may be based on, for example, an area classification of the location of the device 104. For example, the predetermined threshold distance may be larger in a rural environment, and may be shorter if the device 104 is determined to be in an urban or more densely populated environment.

Based on the comparison of the distances between the device 104 and the entities to the predetermined threshold distance, the communities with which the user 112 and the entities are associated may be designated as an active community. For example, if a distance between the user 112 and another user in a common community is less than the predetermined threshold distance, the user 112 and the other user may be designated as “clumped.” The user 112 may be alerted of the active community (e.g., a clump that includes the user 112 and the other user) and a graphic may be presented on the device 104 of the user 112. The graphic may include, for example, the user 112 and the entit(ies) to which it is clumped.

### Clumping Stationary Co-Located Users, Places, and Vehicles

The example system 100 may, for example, use GPS location data of cell phones 104 and connected vehicles that are onboarded to the clumping application to determine when users and connected vehicles should be considered at the same location. Users and vehicles that are determined to be sufficiently co-located may be visually displayed by the clumping application as a clump to indicate that they are together at the same location. If the clumped users and vehicles are at a pre-defined location in the community (e.g., “home”, “work”, “school”), then the clumping application may visually connect the clumping to the pre-defined place. In embodiments, the visual clumping will appear on a map screen of the clumping application executing on the user devices 104. The clumping application on the user devices 104 may also visually distinguish users that are clumped together, for example in a community member list page.

Sufficient proximity of co-location for clumping may, for example, be determined by the clumping application using a combination of the distance between the GPS coordinates of each user, vehicle, and place in the community, and the reverse geocoding of each GPS coordinate to a location's street address. In dense urban environments, the distance between each GPS coordinate may be the dominate factor in clumping users, vehicles, and pre-defined places together. In more sprawling suburban or rural environments the reverse geocoding of each GPS coordinate to an address may play a more significant role in determining if users, vehicles, and pre-defined places should be considered clumped together even when at large distances from each other. For example, multiple users and vehicles may be at a school together and all reverse geocoded to the same address, but may physically be hundreds of meters apart. In contrast, in a dense urban environment, a community of users and vehicles at a pre-defined place may reverse geocode to different addresses, but may be within a few meters of each other and therefore should be considered clumped together. As described below with reference to FIG. 2A, an algorithm for balancing GPS distance thresholds and reverse geocoding address results provides a robust approach to determining sufficient co-location across a variety of potential environmental factors.

FIG. 2A illustrates an example method for clumping users in a community based on location data, in accordance with some embodiments. The example method 200 may, for example, be executed by the system 100 of FIG. 1A. It should be understood that one or more steps of the illustrated method 200 may be performed in a different order than shown in the illustrated example.

At step 1 of the method 200 shown in FIG. 2A, the clumping application is used by consumers to create one or more communities and to invite others to join. As shown, lists of predetermined communities and their associated users may be stored in a communities and members database 202 (e.g., within the telemetry database 106 of FIG. 1A.) In the illustrated example, Consumer ABC 204 is connected within the communities and members database 202 to other consumers in the clumping application. At step 2, physical locations associated with community members (such as home or work addresses) are input to the clumping application. The clumping application may, for example, geocode the community member addresses into latitude/longitude and store this location information in a community locations database 206 (e.g., within the telemetry database 106 of FIG. 1A.)

In order to obtain location data for individual members of a community, the clumping application may request that the users enable their phones or other mobile device to share location data with the clumping application and/or with members of their communities. At step 3, as community member's locations are computed by their phones and shared with the clumping application, those locations are stored in a user location database 208 (e.g., within the telemetry database 106 of FIG. 1A.) At step 4, community members with connected vehicles may enable their vehicle location to be known by the clumping application and/or other members in their community(ies). For example, on a daily cadence, and on key actions within the clumping applications, the connected vehicle's location may be pulled and saved to a vehicle location database 210 (e.g., within the telemetry database 106 of FIG. 1A.) For example, a connected vehicle's location may be pulled and saved to the vehicle location database 210 when the connected vehicle is started or parked, when a user connects or disconnects their device (e.g., device 104 in FIG. 1A) to the vehicle, at predefined time intervals, or based on requests of users.

At step 5, when a community member (e.g., Consumer ABC 204 in the illustrated example) comes to the end of a driving trip, or gets a location update while not driving, the clumping application determines who, or what, the community member might be co-located (“clumped”) with, for example, using a clumping algorithm. An example clumping algorithm executed by the clumping application may, for example, perform the following operations:

| | |
|---|---|
| a. | Determine list of users, locations, and/or vehicles that a community member (e.g., |
| | Consumer ABC) is associated with through one or more predetermined |
| | communities; |
| b. | Retrieve location values for community locations, users, and/or vehicles from |
| | these associated communities from one or more databases (e.g., within the |
| | telemetry database 106 of FIG. 1A.); |
| c. | Determine which location, user, and/or vehicle is clumped to community member |
| | (e.g., Consumer ABC) by: |

| | |
|---|---|
| 1. | Reverse geocode the latitude/longitude on each entity, and declare |
| | clumped if the address matches the community member's (e.g., Consumer |
| | ABC's) reverse geocoded address from the community locations database |
| | 206; and |
| 2. | For any users, locations and/or vehicles that failed the address match |
| | criteria, use the latest location data to run a distance radius test to |
| | determine what locations, users, and/or vehicles are co-located |
| | (“clumped”) to the community member (e.g., Consumer ABC). |

| | |
|---|---|
| d. | Store a list of users, locations, and/or vehicles that are clumped with the |
| | community member (e.g., Consumer ABC) within a clump results database 212 |
| | (e.g., within the telemetry database 106 of FIG. 1A.) |

The example clumping algorithm described above is depicted in FIG. 2B. As shown in the example clumping algorithm 214, at step 216, a list of users, locations, and/or vehicles that the community member 204 is associated with may be determined. The community member 204 may be associated with one or more different predetermined communities. For example, the community member 204 may be associated with a first community that is based on their immediate family. Additionally, the community member 204 may be associated with a second community that is based on an intramural sports league, for example. Next, at step 218, location values for community locations, users, and/or vehicles from these associated communities may be retrieved from one or more databases. For example, a community location of the first community may be a location of a home of the family and a community location of the second community may be a location of a field at which the community member's 204 intramural team practices or performs.

Furthermore, as described in the example clumping algorithm, the locations, users, and/or vehicles to which the community member 204 is clumped may be determined at step 220. This determination may include sub-process 222 of reverse geocoding a latitude and longitude of each entity to obtain an address of the entity, and designating the entity and the community member 204 as clumped if the entity's address matches a reverse geocoded address of the community member 204. Additionally, step 220 may include sub-process 224. As shown at 224, for any users, locations, and/or vehicles that were not determined to be clumped to the community member 204, locations (e.g., latest obtained locations) of the entity and the community member 204 may be used to run a distance radius test to determine which locations, users, and/or vehicles are within sufficient proximity (e.g., within a predetermined distance) to the community member 204 such that the entity and the community member 204 are considered clumped. Furthermore, a list of users, locations, and/or vehicles that are clumped with the community member 204 may be stored within a clump results database 212.

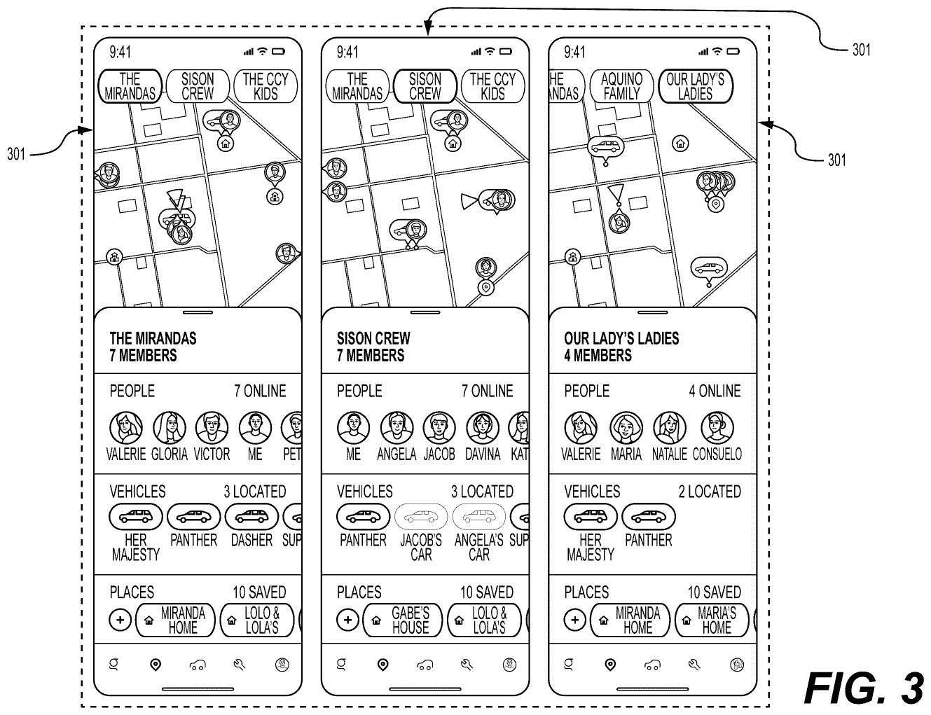

Then, at step 6, when the community member 204 (e.g., Consumer ABC) navigates to a map screen of the clumping application, the clumping application retrieves the list of users, locations and vehicles that the community member is clumped to. The clumping application executing on the community member's device may, for example, retrieve the list via the telemetry server 102, or in other examples may be configured to retrieve the list directly from the clump results database 212. The clumping application may then visually render the clumped group on the map screen, as shown for example in FIGS. 3-7, described below.

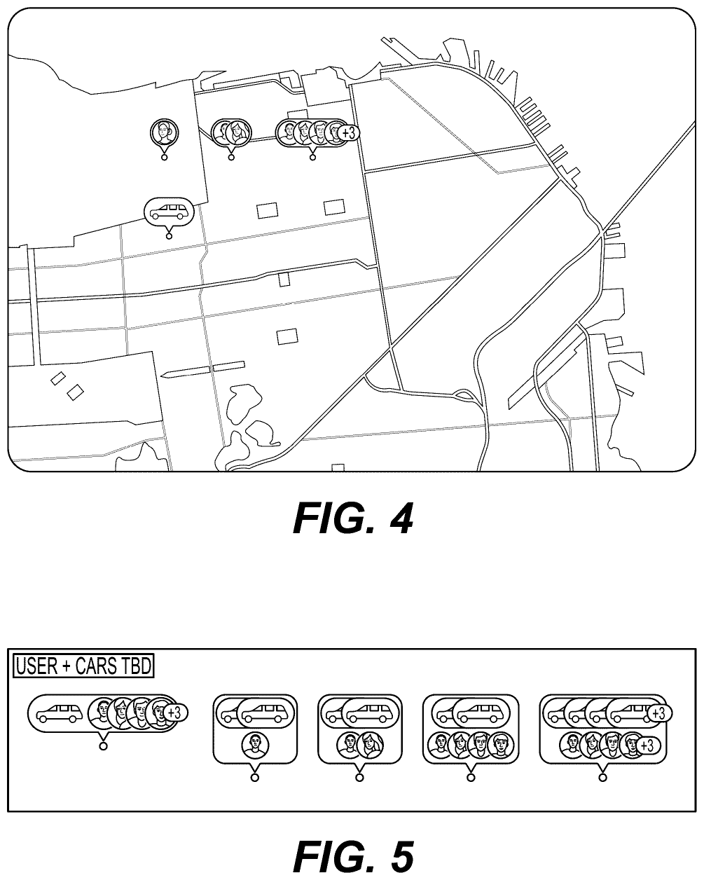

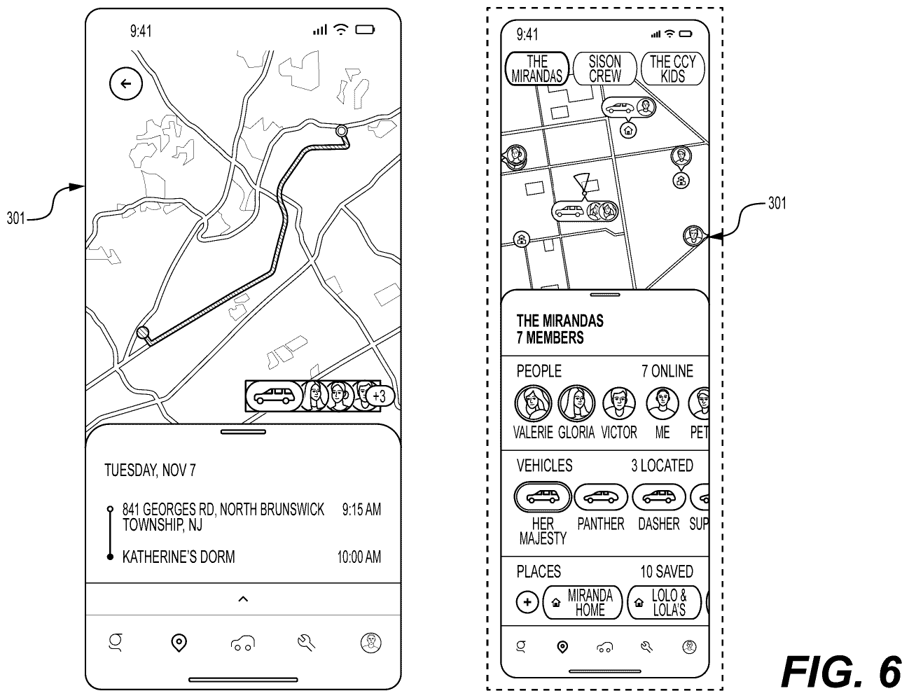

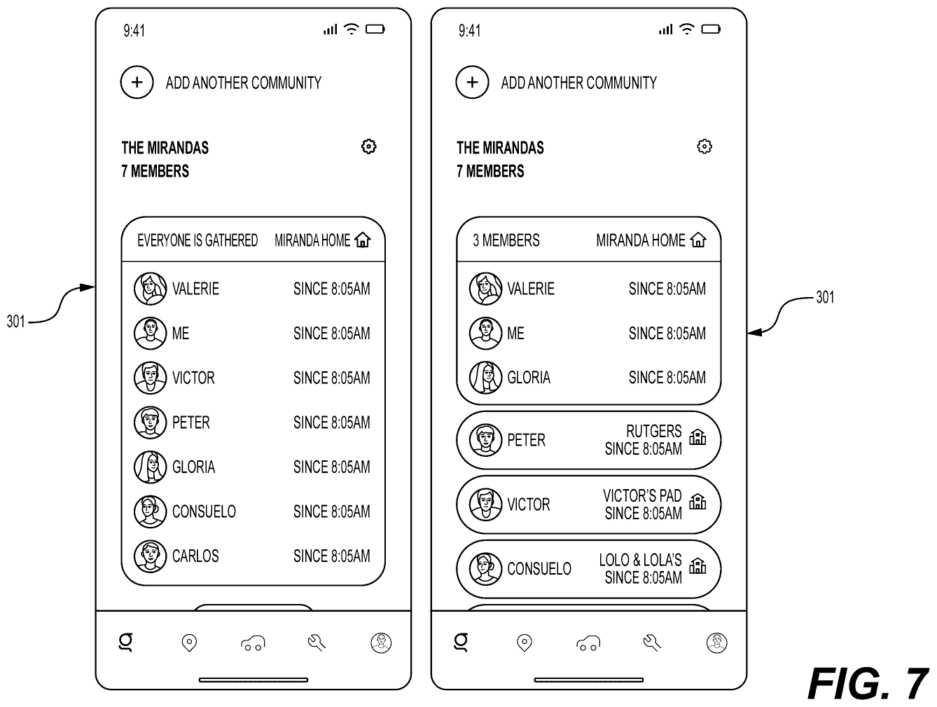

FIG. 3 shows examples of a user interface of the clumping application for three example community members before the community members have been clumped, in accordance with some embodiments. As shown, the example user interface 301 includes a map screen, a list of community members (People), a list of community vehicles associated with the community member(s) (Vehicles), and a list of community locations (Places). FIG. 4 shows an example of the user interface 301 once certain community members have been clumped, in accordance with some embodiments. As shown, clumped community members and vehicles may be displayed within a single icon on a map display within the user interface 301. FIG. 5 illustrates additional examples of icons that may be used to display clumped users and vehicles on the clumping application map display, in accordance with some embodiments. FIG. 6 shows examples of clumping application user interfaces for clumped community members and a vehicle that are travelling together, in accordance with some embodiments. As shown in FIG. 6, the user interface 301 may depict a start time and an estimated time of arrival (ETA) of a trip including a vehicle and users clumped to the vehicle. FIG. 7 shows examples of a community list screen for the clumping application, in accordance with some embodiments. As shown in FIG. 7, the user interface 301 may include an option to add another community to the user interface 301. The community list screen may indicate community members that are currently clumped.

Following is an example of an algorithm for clumping users, vehicles, and places that may be used by one or more embodiment:

```
Receive telemetry data from phone
if (telemetryUserDriving==true AND telemetryMotion==stopped)
  get all associated users for telemetryUser
  foreach associated user
    if (address match OR within distance)
      declare clump
  get all associated vehicles for telemetryUser
  foreach associated vehicle
    if (user is owner or admin)
      pull telematics for vehicle
      if (address match OR within distance)
        declare clump
  get all associated locations for telemetryUser
  foreach associated location
    if (address match OR within distance)
      declare clump
  save clump list to database
  telemetryUserDriving = false
```

The example algorithm described above is depicted in FIG. 2C. As described in the example algorithm 226, telemetry data is received from a device (e.g., a phone) of a first user at 228. If a determination is made at 230 that the first user is driving and the first user is stopped (e.g., a vehicle of the user is parked), all other users associated with the first user are retrieved at 232. Associated users may include, for example, all users being associated with at least one common predetermined community as the first user. For each associated user, a determination is made at 236 as to whether an address of the associated user matches the address of the first user or whether the associated user is within a predetermined distance of the first user. If either the address of the associated user and the first user matches or the first user and associated user are within a predetermined distance, the associated user and the first user are determined to be clumped at 234 and the other user is added to a clump list associated with the first user.

Next, all vehicles associated with the first user are determined at 238. If the user is an owner of the associated vehicle or an administrator (e.g., a delegate administrator, described further below) of the associated vehicle, telematics for the vehicle are pulled. At 240, a determination is made as to whether an address (i.e., location) of the associated vehicle matches the address of the first user or is within a predetermined distance of the first user. If an address of the associated vehicle matches the address of the first user or if a location of the associated vehicle is within a predetermined distance of the first user, the associated vehicle is determined to be clumped to the first user at 234 and the associated vehicle is added to the clump list associated with the first user.

Next, all locations associated with the first user are determined at 242. For example, locations associated with the first user may be a school attended by the first user. For each associated location, a determination is made at 244 as to whether an address of the associated location matches the location of the first user and whether the associated location is within a predetermined distance of the first user. If the address of the associated location matches the location of the first user or the associated location is within the predetermined distance of the first user, the associated location is determined to be clumped to the first user at 234 and the associated location is added to the clump list associated with the first user. The users, vehicles, and associated locations to which the first user is clumped are saved to a database (e.g., the clump result database 212). A determination may then be made that the first user is not driving. This determination may be made, for example, when a user parks a vehicle.

### Clumping Trips Across Users and Vehicles

The method described above with reference to FIG. 2A focuses on operations of the clumping application to clump users, vehicles, and places while stationary. In other examples, users and vehicles may also be clumped while in motion. An example method for clumping users and vehicles while in motion is described below. In this example method, the clumping application determines whether community members in motion are co-located in the same vehicle or mode of travel (e.g., bus, train, motorcycle, etc.), and displays those community members visually clumped together for the duration of travel together. Vehicles that are connected to the clumping application and sharing location data with the community may additionally be visually displayed as clumped to users during travel.

Clumping during a trip may be determined by an algorithm that considers a combination of GPS coordinate proximity distances and vectors of travel of each user and vehicle. For example, the algorithm may include detecting that a first user is moving based on location data (e.g., GPS data) from a first device at a first time and generating a first vector based on the location data. For example, a plurality of positions of the first user and times associated with each of the positions may be obtained. Based on the positions of the location data and differences in times associated with each position, a magnitude (e.g., speed) and direction of the first vector may be determined.

A plurality of entities having a common predetermined community as the first user may be determined. The plurality of common entities may be determined, for example, from a data store or from the database schema structure 110 (FIG. 1B). For one or more of the entities having a common community as the first user, a plurality of bounding telemetry points for the entity is determined (e.g., based on GPS data obtained for the entity). As described below, the bounding telemetry points may be location points within a predetermined radius of the determined location of the entity. The GPS data for the entity may be interpolated to the first time and an entity predicted position may be based on the interpolation. The entity predicted position may represent, for example, a predicted position of the entity at the first time (although, for example, actual location data for the entity at the first time may be unavailable). The interpolation may include, for example, linear point interpretation.

An entity vector may be generated based on the bounding telemetry points. For example, a plurality of location points and times associated with the plurality of location points may be used to generate an entity vector having a magnitude (e.g., speed) and direction. The process of generating the entity vector may be similar to the process described above for generating the first vector. Characteristics (e.g., magnitude, speed, direction) of the first vector and the entity vector are compared. For example, the characteristics may be compared to one or more predetermined thresholds. Based on a determination that the entity predicted position is within a predetermined distance of the first device and that the characteristics of the first vector and the entity vector are within the predetermined thresholds, a determination may be made that the first user and the entity are on a common trip. For example, the first user and the entity may be traveling in a single vehicle. An alert may be graphically rendered on the first device based on the common trip. For example, the alert may be a depiction that the first user and the entity (e.g., other user) are traveling in the vehicle.

The clumping application may, for example, utilize a process of regularly measuring continued co-location during travel to confirm if community members and vehicles should continue to remain visually clumped for the duration of the tracked trip.

When a trip has been determined by the clumping application to have ended, which users and vehicle were clumped together may then be saved to be used in other areas of the application. For example, when a community member looks at their trip history, they may see which other community members were on that same trip and which vehicle was used (assuming the connected vehicles have been onboarded to the clumping application and the vehicle's location was shared to the community).

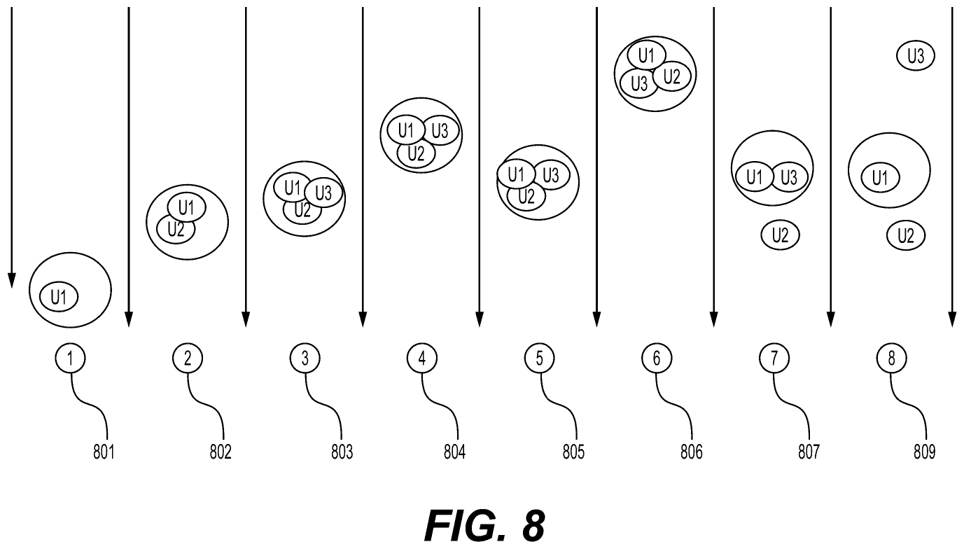

The clumping application may also consider time alignment of the data points. The location data for users and vehicles may be received by the clumping application at different points in time. The clumping application may utilize a method of time alignment to interpolate where the users and vehicles were at a given point in time and space occurring between actual location updates. The clumping application manages two entity types which may be determined to be driving: users and vehicles. These two entity types may be managed separately because both entities have their own unique data source. For example, users may be tracked based on phone GPS data and connected vehicles may be tracked using the vehicles' onboard GPS system. As the clumping application tracks these entity types, the system detects if instances of these entities are moving together, i.e., clumped together. To track users that are moving and clumped together, the clumping application looks for two points in time when the users are co-located and have the same speed, accounting for some margin of error (i.e., a predetermined margin of error). FIG. 8 illustrates an example operation of the clumping application after time alignment has occurred.

FIG. 8 illustrates an example in which the clumping application detects that a plurality of community members are driving together, in accordance with some embodiments. In the example shown in FIG. 8, the clumping application detects that three community members (U1, U2, U3) are individually moving in a driving state, based on their devices (e.g., phones), and iteratively clumps the group together. At step 1 801, the clumping application detects that U1 has started driving. Since no other community member is driving at this point, U1 is clumped to no one. At step 2 802, the clumping application detects that U2 has starting driving. Since U1 is also in a drive state, the clumping application for U2 checks if their distance is co-located and if their speeds match. If so, U2 is provisionally clumped to U1.

In step 3 803, at the next telemetry update for U2, U2 again passes the co-located and speed criteria to clump to U1. As this is the second data point match for clumping between U2 and U1, the clumping application declares that U2 and U1 are clumped together. At the same time, the location for U3 is updated, but not detected to be driving, therefore, U3 is not qualified for clumping yet. Then, at step 4 804, the clumping application detects that U3 has started driving. Since U1 & U2 are also in a drive state, the clumping application for U3 checks if their distance is co-located and if their speeds match. If so, U3 is provisionally clumped to U1 & U2.

In step 5 805, at the next telemetry update for U3, U3 again passes the co-located and speed criteria to clump to U1 & U2. As this is the second data point match for clumping between U3 and U1 & U2, the clumping application declares that U3, U2, and U1 are clumped together. The clumping application then performs a periodic check at step 6 806, which results in U1, U2, U3 staying clumped together because they are moving together at the same speed.

At step 7 807, a periodic check by the clumping application shows that U2 is no longer driving, while U1 and U3 are still driving. Likely this means that U2 was dropped off and U1 and U3 continued on. Since U2 is no longer driving at step 7 807, U2 is declared to no long be clumped to U1 or U3. Besides a state of not driving, the distance and speed check fails for U2, compared to U1 and U3. The failure of either of these criteria are also conditions to de-clump U2. Finally, at step 8 808, U3 is detected to be de-clumped from U1, for similar conditions as U2 in step 7 807.

The algorithm described above may also be used by the clumping application to detect if community members and connected vehicles are clumped together (speed criteria is not used if speed is not available). In this scenario, a time delay is introduced in the checking of the clump rules. This delay allows for the latency of retrieving connected vehicle telemetry data, since user telemetry (i.e., from the phone) is retrieved at a rate magnitudes faster than connected vehicle data.

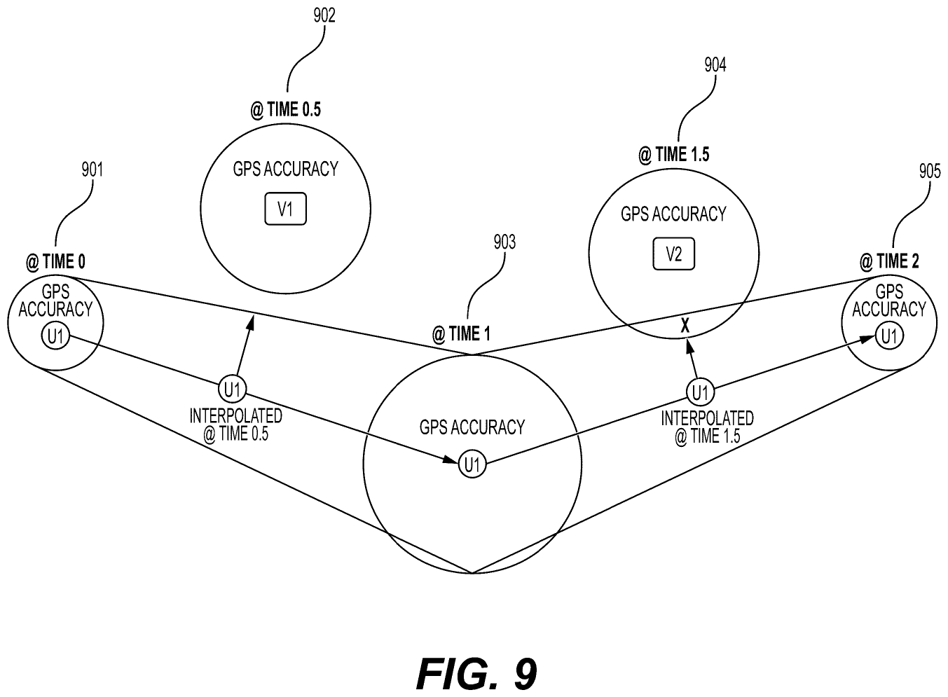

In the algorithm described above, whether for user-to-user clumping or user-to-vehicle clumping, all data points may be time-aligned through interpolation before location and speed are compared. FIG. 9 depicts an example of interpolating locations of users and vehicles, in accordance with some embodiments. The diagram shown in FIG. 9 illustrates how data points might be recorded across a space at each timestep before any time alignment is done. In the example shown in FIG. 9, the community member “u1” is receiving location updates at times 0 (901), 1 (903), and 2 (905). The vehicle “v1” has received a location update at time 0.5 (902), and vehicle “v2” has received a location update at time 1.5 (904). Interpolating where user “u1” was at time 0.5 (902) and 1.5 (904), the clumping application can then compare this to the singular location readings for vehicle “v1” at time 0.5 (902) and “v2” at time 1.5 (904). The illustrated method results in an assumed co-location between user “u1” and vehicle “v2” for the observation period, but not for user “u1” and vehicle “v1”.

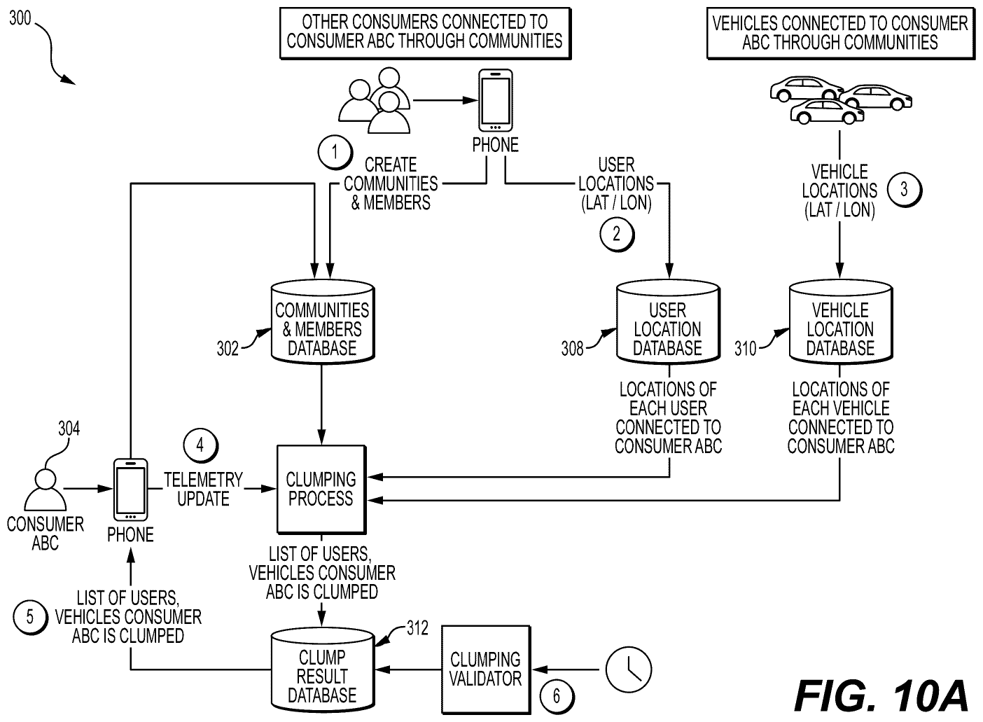

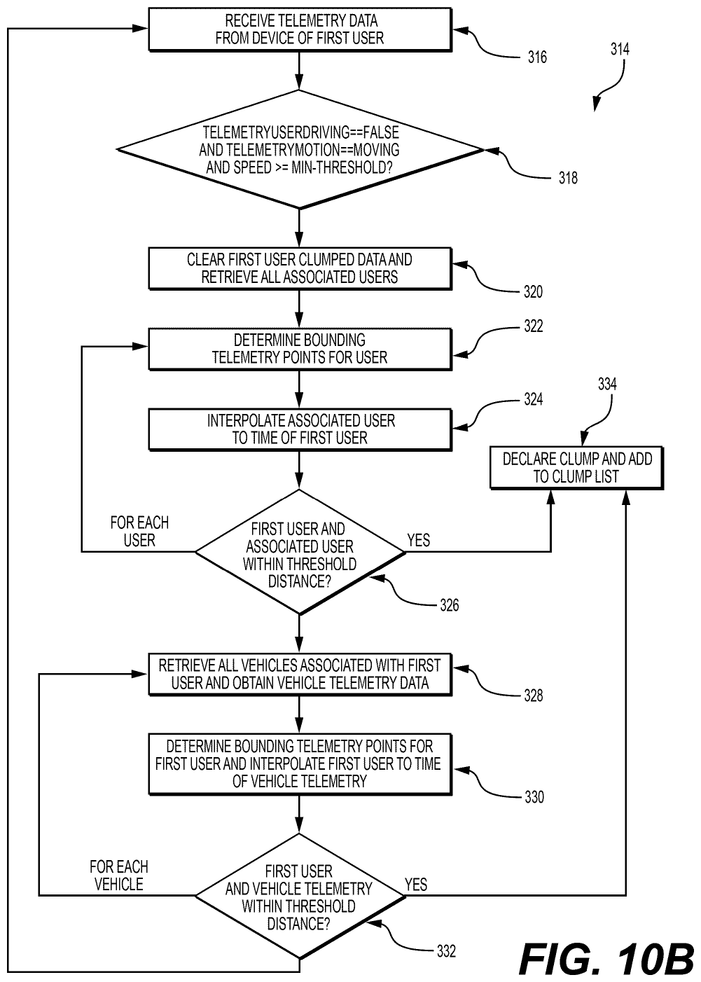

FIG. 10A depicts an example method for managing data and clumping community members and vehicles in motion, in accordance with some embodiments. The example method 200 may, for example, be executed by the system 100 of FIG. 1A. It should be understood that one or more steps of the illustrated method 300 may be performed in a different order than shown in the illustrated example.

At step 1 of the method 300 shown in FIG. 10A, the clumping application is used by consumers to create one or more communities and to invite others to join. As shown, lists of predetermined communities and their associated users may be stored in a communities and members database 302 (e.g., within the telemetry database 106 of FIG. 1A.) In the illustrated example, Consumer ABC 304 is connected within the communities and members database to other consumers in the clumping application. At step 2, as community member's locations are computed by their devices and shared with the clumping application, those locations are stored in a user location database 308 (e.g., within the telemetry database 106 of FIG. 1A.) The clumping application may only perform user-to-user clumping while moving between users that have community associations. At step 3, community members with connected vehicles may enable their vehicle location to be known by the clumping application and/or other members in their community(ies), and the vehicle locations are stored to a vehicle location database 310 (e.g., within the telemetry database 106 of FIG. 1A.) The clumping application may only perform clumping of users to vehicles between users that have community associations.

At step 4, when the community member (Consumer ABC in the illustrated example) updates its telemetry data and is found to be moving, the clumping application executes the clumping algorithm based on the telemetry data available, which may result in clumping or de-clumping, with the clumping results stored to a clump result database 312 (e.g., within the telemetry database 106 of FIG. 1A.) At step 5, the clumping data is presented to the clumping application executing on the community member's phone. Then, at step 6, the clumping application periodically checks on the clumping results to de-clump as needed.

Following is an example of an algorithm for clumping trips across users and vehicles that may be used by one or more embodiment:

```
Receive telemetry data from phone
if (telemetryUserDriving==false AND telemetryMotion==moving AND speed>=min-
threshold)
  clear telemetryUser clumped data
  get all associated users for telemetryUser
  foreach associated user
    find bounding telemetry points for associated user
    interpolate associated user to time of telemetryUser (linear point interpolation)
    if (telemetryUser and associatedUser are within threshold distance for driving
together)
      declared clump
  foreach associated connected vehicle
    repeat 2 times
      get vehicle telemetry data
      find bounding telemetry points for telemetryUser
      interpolate telemetryUser to time of vehicleTelemetry (linear point interpolation)
      if (telemetryUser and vehicleTelemetry are within threshold distance for driving
together)
        declared clump
  save clump list to database
  telemetryUserDriving = true
```

The example algorithm described above is depicted in FIG. 10B. As described in the example algorithm 314, telemetry data is received from a device (e.g., phone) of a first user at 316. If a determination is made at 318 that the first user is not driving and the first user is moving (e.g., exceeding a predetermined speed), and the speed of the first user is equal to or greater than a predetermined speed, the first users clumped data is cleared at 318. Furthermore, all users associated with the first user are retrieved at 320. As described above, the associated users may be users being associated with at least one community with which the first user is also associated. For each associated user, bounding telemetry points of the associated user may be obtained at 322. The bounding telemetry points may be for example, points within a predetermined radius of a determined location of the associated user. The predetermined radius may be determined, for example, based on a margin of error of the location (e.g., due to inherent inaccuracies of measurement equipment or methodology).

Next, a location of the first user may be interpolated to a time at which the determined location of the associated user was obtained. For example, linear point interpolation may be utilized. If the bounding telemetry points of the associated user and the interpolated location of the first user are within a predetermined threshold distance (e.g., a distance sufficient to determine that the first user and the associated user are driving together), the first user and the associated user are determined to be clumped at 334 and the associated user may be added to a clump list associated with the first user.

For each connected vehicle associated with the first user, the following process may repeat one or more (e.g., two) times. Telemetry data of the associated vehicle is obtained at 328. The telemetry data may include, for example, a location of the associated vehicle. The bounding telemetry points for the first user may be obtained at 330. Additionally, at 330 a location of the first user may be interpolated to a time at which the location of the associated vehicle was obtained (e.g., through linear point interpolation). If the first user and the associated vehicle are determined to be within sufficient proximity (e.g., within a predetermined threshold distance), the associated vehicle is clumped to the first user at 334 and the associated vehicle is added to the clump list associated with the first user. A list of users and vehicles that are clumped to the first user is stored in a database (e.g., clump result database 212).

### Using Mobile Device Data as a Proxy for Vehicle Telemetry Data

In embodiments, the telemetry system and clumping application may be used to enable user mobile device data to be used as a proxy for vehicle telemetry data. Due to constraints with current connected vehicles, systems may only receive vehicle location data with gaps of multiple minutes between updates, and may not be able to receive any vehicle speed, accelerometer, or similar vehicle driving telemetry data from the connected vehicle. To address this concern, embodiments of the telemetry system may extend the method of clumping users to connected vehicles described above, such that once a user is clumped to a vehicle, for the duration of that clumped trip, the clumping application is able to fill in the gaps of the vehicle's location data and other driving telemetry data by using a collection of data from the users' mobile devices that are determined to be clumped with the vehicle for that period of time.

For example, mobile device telemetry data may be received from a cellular network that specifies a location of a mobile device. A mobile device vector may be generated based on the mobile device telemetry data. The generation of the mobile device vector may include obtaining a plurality of location data points of the first device and times associated with each of the plurality of location data points. A magnitude (e.g., speed) and direction of the mobile device vector may be generated based on the location data points and differences in the times associated with various data points, as described further above. Furthermore, vehicle telemetry data for a vehicle may be received. The vehicle telemetry data may be received, for example, from a telemetry control unit (TCU) within the vehicle. Based on the vehicle telemetry data, a vehicle vector may be generated. The generation of the vehicle vector may be effectuated, for example, based on similar processes used to generate the mobile device data.

A determination is made that a characteristic of the vehicle vector is within a predetermined threshold of the characteristic of the mobile device vector. For example, a determination may be made based on the mobile device vector and the vehicle vector that the mobile device (and thus the user associated with the device) and the vehicle are traveling at speeds within a predetermined speed of each other. While the characteristic of the vehicle vector is within the characteristic of the mobile device vector, the mobile device telemetry data is attributed to the vehicle telemetry data. For example, in the network 114 depicted in FIG. 1B, mobile device data stored in the mobile device data store 126 may be mapped to locations associated with the vehicle in the map data store 130. Based on a detecting that the characteristic of the vehicle vector is not within the predetermined threshold of the characteristic of the mobile device vector, the attribution of the mobile device telemetry data to the vehicle telemetry data may cease (e.g., clear).

The use of the user's mobile device data as a proxy for vehicle data enables the clumping application to assign high frequency location, accelerometer, heading, and similar driving telemetry data derived from users' mobile devices to a clumped vehicle. This enables the clumping application to be used to determine how a vehicle was driven and may, for example, be used to provide impact recommendations such as wear and tear repairs like brakes and tires. In embodiments, the use of the user's mobile device as a proxy for the vehicle may also enable the telemetry system to reduce when the clumping application calls the vehicle for data, since the mobile device data may be used in place of the vehicle for the duration of a trip. Furthermore, the user of the user's mobile device data as a proxy for vehicle data may reduce the need to further wake up and request data from other vehicles associated with a community, since those vehicles may have been determined to not be clumped to a user. Accordingly, calls for additional location updates from such vehicles may be reduced until another trip starts in the future.

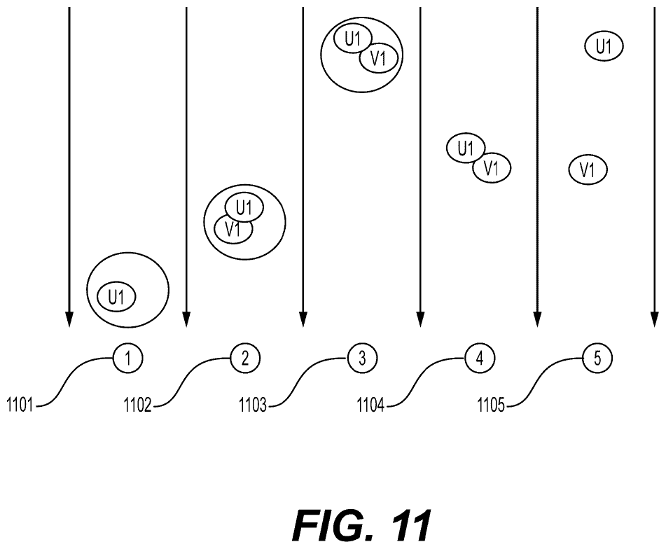

FIG. 11 depicts an example of using mobile device data to supplement vehicle data, in accordance with some embodiments. As noted above, when a community member and vehicle are clumped within the telemetry system, the clumping application may utilize the community member's phone telemetry to supplement the vehicle's telemetry. In the example illustrated in FIG. 11, the clumping application detects that community member “U1” is driving at step 1 1101. At step 2 1102, the clumping application detects community member “U1” and community vehicle “V1” to be driving and clumped together (as described above, this clumping may take several steps). Then, at step 3 1103, the telemetry data of community member U1 is attributed to vehicle V1. Items such as distance traveled, speed, acceleration and deceleration, harshness of driving, etc., may be attributed to both the user and the vehicle. At step 4 1104, the trip has stopped and now U1 and V1 are not clumped together. As U1 moves in step 5 1105, the community member's phone telemetry is no longer associated with vehicle V1.

In the illustrated examples, whether for user-to-user clumping, or user-to-vehicle clumping, all data points are time aligned through interpolation before location and speed are compared.

Following is an example of an algorithm for using mobile data as a proxy for vehicle telemetry data that may be used by one or more embodiment:

```
receive telemetry data for telemetryUser
if (telemetryUser is clumped to a vehicle and user is user selected to associate to vehicle
data)
  vehicleTelemetry.time = telemetryUser.time
  vehicleTelemetry.lat = telemetryUser.lat
  vehicleTelemetry.lon = telemetryUser.lon
  vehicleTelemetry.speed = telemetryUser.speed
  vehicleTelemetry.heading = telemetryUser.heading
  compute distance from current lat/lon and prev lat/lon
  add computed distance to odometer of vehicle
```

As shown in the example algorithm, telemetry data for a first user is received. If the first user is clumped to a vehicle and the first user is selected to associate to data of the vehicle, parameters of the user (e.g., of the user's device 104) are attributed to the vehicle. For example, a time at which the data was obtained is attributed from the user to the vehicle. Furthermore, latitude and longitude measurements of the user and speed of the user are attributed (i.e., assigned) to the vehicle. A distance traveled by the vehicle is computed based on current latitude and longitude data and previous latitude and longitude data. The computed distance traveled is added to an odometer of the vehicle.

### Sharing Ability to View and Manage Vehicles Across a Community of Users

The clumping application may enable a user to onboard a vehicle in one of two states: (1) connected, or (2) unconnected. For any vehicle onboarding state, the person who onboarded the vehicle (aka the “owner”) may be able to delegate administration of that vehicle through the clumping application to another person with which they share a community (e.g., their spouse, child, roommate, etc.) For a connected vehicle, the delegate administrator may, for example, be able to remote lock/unlock the vehicle, view the vehicle stats such as fuel level, tire pressure, odometer, oil life, state of charge (EV), depending on what data the vehicle transmits and is capable of. For both connected and unconnected cars, the clumping application may enable the delegate administrator to do things like add records to the service history (e.g., DIY oil change), view the vehicle estimated valuation information, or even schedule maintenance/repair services for that vehicle. Any alerts/notification relevant for a vehicle, such as low fuel, low tire pressure, service due, recall, etc., may be communicated not only to the owner, but also any delegate administrators. The clumping application may thus be utilized to select a community vehicle and delegating visibility, control, and management to a group of people.

For example, a delegation request may be received over a telemetry network (e.g., telemetry network 114 (FIG. 1B)) from a first device associated with a first user. The delegation request may specify a second user and a vehicle. A telemetry database may be accessed and a determination may be made that the first user and the second user are associated with (e.g., members of) a common predetermined community. For example, the community table 122 (FIG. 1B) may indicate that the first user and the second user are associated with a common predetermined community. Based on the delegation request and the determination that the first user and the second user are members of the common predetermined community, a plurality of administrative control privileges is distributed to a second device associated with the second user via the telemetry network. The plurality of administrative control privileges allows the second device mobile access privileges to the vehicle. In some examples, the administrative control privileges allows the second device to access vehicle history reports, or to remotely lock and unlock the vehicle.

Following is an example of an algorithm for sharing the ability to view and manage vehicles across a community of users that may be used by one or more embodiment:

```
On mobile app:
  Load map screen
  Start telemetry stream
      call backend API to get all associated users, vehicles, locations and their clumping
      foreach user
          render on map
      foreach vehicle
          render on map
      foreach location
          render on map
On backend:
    Process REST call to get all associated entities for a user
      Set associated users = all other users in communities the primary user is in
      Set associated vehicles = all vehicles user owns
      Append to associated vehicles = all vehicles user has been given admin rights to
      Set associated locations = all locations in communities that user is part of
    Process REST call to get telemetry data
      foreach user, vehicle, location requested
        verify entity has association to user
        if not
            reject and return empty
```

As described in the example algorithm, on a mobile application (e.g., the clumping application), a map screen is loaded. A telemetry stream is then started. A backend Application Programming Interface (API) is called to obtain all associated users, vehicles, locations, and entities to which a community member is clumped. For each user, vehicle, and location to which the community member is clumped, the clumped entity is rendered on the map screen.

On the backend API, a call (e.g., a Representational State Transfer (REST) call) is processed to obtain all associated entities for the community member. Associated users are determined to be all other users belonging to at least one community in common with the community member. Associated vehicles are determined to be all vehicles owned by the community member. Vehicles of which the community member has sufficient authority (e.g., a delegate administrator) are also appended to the list of associated vehicles. Associated locations is determined to be all locations associated with communities of which the community member is a member. A backend API call is then processed to obtain telemetry data for each user, vehicle, and location specified in a request to view and manage a vehicle. For each user, vehicle, and location specified in the request, a verification is performed to confirm that the entity is associated with the community member. If the entity is not associated with the community member, the request is rejected.

It will be appreciated by those skilled in the art that changes could be made to the embodiments described above without departing from the broad inventive concept thereof. It is understood, therefore, that the invention disclosed herein is not limited to the particular embodiments disclosed, and is intended to cover modifications within the spirit and scope of the present invention.

What is claimed is:

1. A clumping system comprising:
a telemetry server accessible by a first device associated with a first user, the telemetry server configured to receive Global Positioning System (GPS) data from the first device and determine a location and an area classification of the location of the first user based on the GPS data; and
a clumping application, stored on a non-transitory computer-readable medium and executed by one or more processors, configured to:
receive a community of the first user and identities of a plurality of entities within the community from a telemetry database;
determine locations of the plurality of entities based on GPS data from devices associated with the entities;
compare distances between the location of the first user and the locations of the entities to a predetermined threshold that is based on the area classification;
based on the comparison of the distances between the location of the first user and the locations of the entities to a predetermined threshold, designate the community as an active community; and
alert the first user of the active community and graphically render the active community on the first device.

2. The clumping system of claim 1, wherein the determination of the location of the first user comprises reverse geocoding the GPS data from the first device and wherein the determination of the locations of the plurality of entities comprises reverse geocoding the GPS data from the devices associated with the entities, the clumping application further configured to determine whether the first user and the entities based on the reverse geocoding of the GPS data from the first device and from the devices associated with the entities.

3. The clumping system of claim 1, wherein the plurality of entities include one or more community members within the community, one or more vehicles within the community, and one or more locations within the community.

4. The clumping system of claim 1, wherein the area classification includes a rural classification and an urban classification.

5. The clumping system of claim 1, wherein each of the steps the clumping application is configured to perform are performed in response to a detected driving action of the first user.

6. A method comprising:
detecting that a first user is moving based on Global Positioning System (GPS) data from a first device at a first time and generating a first vector based on the GPS data;
determining, from a data store, a plurality of entities within a common predetermined community as the first user;
for one or more of the entities:
determining a plurality of bounding telemetry points for the entity based on GPS data obtained for the entity;
interpolating the GPS data for the entity to the first time, an entity predicted position generated based on the interpolation;
generating an entity vector based on the bounding telemetry points; and
based on a determination that the entity predicted position is within a predetermined distance of the first device and that characteristics of the first vector and the entity vector are within predetermined thresholds, determining that the first user and the entity are on a common trip; and
graphically rendering an alert on the first device based on the common trip.

7. The method of claim 6, wherein the characteristics of the first vector and the entity vector include a magnitude and a direction of travel.

8. The method of claim 6, wherein the plurality of entities include a community member and a vehicle.

9. The method of claim 6, wherein the interpolation of the GPS data for the entity to the first time is a linear point interpolation.

10. The method of claim 6, wherein the method is performed continually at predetermined time intervals for a predetermined time.

11. A method of using mobile device data as a proxy for vehicle data comprising:
receiving, from a cellular network, mobile device telemetry data specifying a location of the mobile device;
generating a mobile device vector based on the mobile device telemetry data;
receiving vehicle telemetry data from a telemetry control unit (TCU) in a vehicle;
generating a vehicle vector based on the vehicle telemetry data;
determining that a characteristic of the vehicle vector is within a predetermined threshold of a characteristic of the mobile device vector;
while the characteristic of the vehicle vector is within the predetermined threshold of the characteristic of the mobile device vector, attributing the mobile device telemetry data to the vehicle telemetry data; and
clearing the attribution of the mobile device telemetry data to the vehicle telemetry data based on detecting that the characteristic of the vehicle vector is not within the predetermined threshold of the characteristic of the mobile device vector.

12. The method of claim 11, further comprising determining a recommended maintenance or repair action of the vehicle based on the mobile device telemetry data and generating an alert on the mobile device based on the recommended maintenance or repair action.

13. The method of claim 11, wherein the characteristic of the mobile device vector and the vehicle vector is a speed.

14. The method of claim 11, further comprising determining a distance traveled by the vehicle based on the attribution of the mobile device telemetry data to the vehicle telemetry data, and updating an odometer of the vehicle based on the distance traveled.

15. The method of claim 11, further comprising reducing a rate at which the vehicle telemetry data is received while the mobile device telemetry data is attributed to the vehicle telemetry data.

16. A method comprising:
receiving, over a telemetry network, a delegation request from a first device associated with a first user, the delegation request specifying a second user and a vehicle;
accessing a telemetry database and determining that the first and second users are members of a common predetermined community based on community data within the telemetry database; and
based on the delegation request and the determination that the first and second users are members of the common predetermined community, distributing a plurality of administrative control privileges to a second device associated with the second user via the telemetry network, the plurality of administrative control privileges allowing the second device mobile access privileges to the vehicle.

17. The method of claim 16, further comprising determining whether the second user is connected to the vehicle or not connected to the vehicle, wherein the second user is able to lock and unlock the vehicle remotely based on a determination that the second user is connected to the vehicle.

18. The method of claim 16, wherein the mobile access privileges include viewing parameters of the vehicle.

19. The method of claim 16, wherein the mobile access privileges include modifying a service history of the vehicle.

20. The method of claim 16, further comprising alerting the first user and the second user of notifications of the vehicle based on the administrative control privileges.
